(19) United States
(12) Patent Application Publication
(10) Pub. No.: US 2010/0153100 A1
(43) Pub. Date: Jun. 17, 2010

(54) ADDRESS GENERATOR FOR SEARCHING ALGEBRAIC CODEBOOK

(75) Inventors: Byun Kyung Jin, Daejeon (KR); Koo Bon Tae, Daejeon (KR); Eum Nak Woong, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/553,736

(22) Filed: Sep. 3, 2009

(30) Foreign Application Priority Data
Dec. 11, 2008 (KR) 10-2008-0125843
Mar. 31, 2009 (KR) 10-2009-0027317

(51) Int. Cl. G10L 19/00

(52) U.S. Cl. 704/219; 704/E19.023

(57) ABSTRACT

An address generator for searching an algebraic codebook is disclosed. The address generator includes: a multiplier multiplying the dimension and a width value of a correlation matrix; a first adder adding a length value and an offset address of the correlation matrix; and a second adder adding the results of the multiplier and the first adder to generate an address for algebraic codebook searching. The amount of calculation required for an address calculation to search an algebraic codebook can be reduced.

### CROSS-REFERENCE TO RELATED APPLICATIONS

This application claims the priorities of Korean Patent Application Nos. 2008-125843 filed on Dec. 11, 2008 and 2009-27317 filed on Mar. 31, 2009, in the Korean Intellectual Property Office, the disclosures of which are incorporated herein by reference.

### BACKGROUND OF THE INVENTION

1. Field of the Invention

The present application relates to a technique that searches an algebraic codebook in an ACELP-type voice codec and, more particularly, to an address generator for searching an algebraic codebook capable of reducing the amount of calculation (i.e., computation) required for searching an algebraic codebook.

2. Description of the Related Art

A digital mobile communications system uses diverse voice coding algorithms to effectively use the bandwidth of a transport channel and to allow high sound quality call communications in a radio channel environment.

In general, among voice codec algorithms, a code excited linear prediction (CELP) algorithm adopted by various standards has very good performance at a low transmission rate of 4 kbps to 8 kbps. The CELP algorithm has evolved to become an algebraic CELP (ACELP) that shortens time required to search a fixed codebook and does not require a memory, and recently, it has been widely employed and used for most world communications standards.

An algebraic codebook algorithm adopted by an ACELP voice codec does not use a codebook for modeling excitation signals, removing the necessity of storage space for a codebook, and because it employs effective codebook searching methods, it can perform a search with minimal amount of calculation.

However, in the case of the algebraic codebook algorithm, a relatively large amount of calculation is required for the process of searching for the position and size of a pulse of an excitation signal having the smallest error over a target signal.

Thus, in an effort to reduce the amount of calculation required in the searching process, it has been proposed that a focused search method, a depth first tree search method, or a similar method be used. In the focused search method used for a G.729 voice codec, the search range is limited by using a threshold value, and in the depth first tree search method used for a G.729A voice codec, searching is performed only on a path that satisfies a local maximum value, to more effectively reduce the amount of calculation. Most other ACELP-type voice codecs employ the focused search method, the depth first tree search method and similar methods in order to reduce the amount of calculation required for searching.

In general, the real time implementation of voice codecs is made by using a general digital signal processor (DSP). Namely, a general DSP suitable for a voice code algorithm desired to be implemented is selected and its characteristics are used at their maximum level by using a compiler, an assembler, and the like, to obtain optimum implementation results.

If necessary, a DSP that can optimize the algorithm of a voice codec may be customized, based on which the voice codec may be implemented to obtain optimum performance.

However, such implementation methods require a long development period of a DSP, and a developed DSP may allow for the optimum implementation of a specific voice codec algorithm but obtain worse results in implementing a voice codec using a different algorithm.

Meanwhile, in the algebraic codebook searching the ACELP-type voice codec, correlation matrix values are previously calculated before performing a search, and are used during a searching process.

However, such correlation matrix values are two-dimensional array values, while those actually stored in a memory are arranged one-dimensionally.

In order to use the correlation matrix values, stored in the one-dimensional array, in the algebraic codebook search process, a proper address computation should be performed, and in this case, if the correlation matrix values are implemented in a general commercial DSP assembly language, a calculation amount of about 5 cycles is required.

Such computation must be repeated continuously in the algebraic codebook search process, which is a major factor in increasing the amount of calculation required in the algebraic codebook searching process.

### SUMMARY OF THE INVENTION

An aspect of the present application provides an address generator capable of simply generating an address value of a memory storing correlation matrix values in order to reduce the amount of calculation required for accessing the correlation matrix values forming a great deal of weight in the algebraic codebook searching process.

According to an aspect of the present invention, there is provided an address generator including: a multiplier multiplying a dimension and a width value of a correlation matrix; a first adder adding a length value and an offset address of the correlation matrix; and a second adder adding the results of the multiplier and the first adder to generate an address for algebraic codebook searching.

The address generator may further include: a register storing the computation results of the second adder.

The address generated by the second adder is an address to be first accessed in a memory of the correlation matrix.

According to another aspect of the present invention, there is provided an encoding device of an ACELP-type voice codec including: an address generator generating an address to access a memory, wherein the memory stores correlation matrix values in one-dimensional array; an algebraic codebook searching unit accessing the memory using the address to obtain the correlation matrix values required for searching an algebraic codebook.

The correlation matrix values are two-dimensional array values.

The address generator including: a multiplier multiplying a dimension and a width value of a correlation matrix; a first adder adding a length value and an offset address of the correlation matrix; and a second adder adding the results of the multiplier and the first adder to generate an address for algebraic codebook searching.

The address generator further including: a register storing the computation results of the second adder.

The address generated by the second adder is an address to be first accessed in a memory of the correlation matrix.

### BRIEF DESCRIPTION OF THE DRAWINGS

The above and other aspects, features and other advantages of the present application will be more clearly understood from the following detailed description taken in conjunction with the accompanying drawings, in which:

FIG. 1 is a schematic block diagram of an encoding device of a general ACELP-type voice codec;

FIG. 2 illustrates C codes for searching an algebraic codebook of a TETRA codec, one of the ACELP-type voice codecs;

FIG. 3 illustrates a correlation matrix for searching an algebraic codebook;

FIG. 4 illustrates the process of storing a correlation matrix array of FIG. 3 in a one-dimensional memory when the correlation matrix array is implemented in real time by using a DSP; and

FIG. 5 is a schematic block diagram of an address generator according to an exemplary embodiment of the present invention.

### DETAILED DESCRIPTION OF THE PREFERRED EMBODIMENT

Exemplary embodiments of the present application will now be described in detail with reference to the accompanying drawings. The invention may, however, be embodied in many different forms and should not be construed as limited to the embodiments set forth herein. Rather, these embodiments are provided so that this disclosure will be thorough and complete, and will fully convey the scope of the invention to those skilled in the art. In describing the present invention, if a detailed explanation for a related known function or construction is considered to unnecessarily divert the gist of the present invention, such explanation will be omitted but would be understood by those skilled in the art.

In the drawings, the shapes and dimensions may be exaggerated for clarity, and the same reference numerals will be used throughout to designate the same or like components.

Unless explicitly described to the contrary, the word “comprise” and variations such as “comprises” or “comprising,” will be understood to imply the inclusion of stated elements but not the exclusion of any other elements.

Before describing an address generator according to an exemplary embodiment of the present invention, an encoding device of a general ACELP-type voice codec, a code for searching an algebraic codebook, a correlation matrix for searching the algebraic codebook, and a process of storing a correlation matrix array in a one-dimensional memory when the correlation matrix array is implemented in real time by using a DSP will be described first to aid in understanding the present invention.

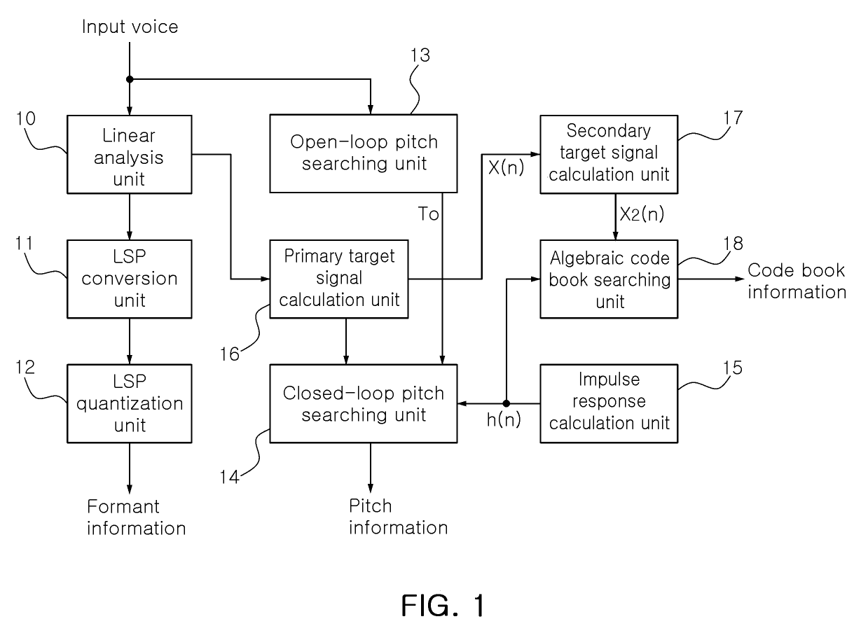

FIG. 1 is a schematic block diagram of an encoding device of a general ACELP-type voice codec.

With reference to FIG. 1, the encoding device of the ACELP-type voice codec includes a linear analysis unit 10, a line spectral pair (LSP) conversion unit 11, an LSP quantization unit 12, an open-loop pitch searching unit 13, a closed-loop pitch searching unit 14, an impulse response calculation unit 15, a primary target signal calculation unit 16, a secondary target signal calculation unit 17, and an algebraic codebook searching unit 18.

The linear analysis unit 10 obtains a tenth LPC coefficient by using 160 samples (20 milliseconds) of a voice signal sampled at 8 kHz as one frame. In case of a high bit rate, the linear analysis unit 10 performs linear analyzing on each frame twice, while in most cases, the linear analysis unit 10 performs linear analysis on each frame only once.

The LSP conversion unit 11 reduces quantization distortion and transmission errors in the LPC coefficient and converts the LSP coefficient into one having good interpolation characteristics.

The LSP quantization unit 12 performs vector quantization on the LSP coefficient through various algorithms such as split matrix quantization (SMQ), split vector quantization (SVQ), and the like.

The open-loop pitch searching unit 13 preferentially determines an integer delay value through an open-loop pitch searching operation to reduce the amount of calculation required for pitch searching.

The closed-loop pitch searching unit 14 performs a closed-loop searching operation only on adjacent values based on the constant delay value determined by the open-loop pitch searching unit 13. In this case, the open-loop pitch searching operation is performed on a weighted voice signal, and in case of a low transmission rate, the open-loop pitch searching operation is performed once, and in case of a high transmission rate, the open-loop pitch searching operation is performed twice.

When the open-loop searching operation is finished, the impulse response calculation unit 15 and the primary target signal calculation unit 16 calculate an impulse response (h (n)) and a primary target signal (x(n)) for closed-loop searching. In this case, the primary target signal (x(n)) is calculated by removing a quiescent response signal of a weight synthesizing filter from the weighted input voice signal. In the closed-loop searching operation, a delay value of an integer value minimizing a mean square error with a voice signal synthesized with a target signal is determined over the adjacent values of the previously obtained open-loop delay value.

The secondary target signal calculation unit 17 calculates a secondary target signal (X₂(n)) to search an algebraic codebook. The secondary target signal (X₂(n)) is obtained by removing a pitch component from the primary target signal (x(n)).

The algebraic codebook searching unit 18 determines the position and sign of a pulse minimizing a mean square error with a voice signal synthesized with the secondary target signal (X₂(n)). Namely, the algebraic codebook searching unit 18 searches an algebraic codebook.

The algebraic codebook takes up a large portion of the bit allocation in the ACELP-type voice codec, and scores to one pulse per subframe may be used according to various bit rates.

For example, a subframe is divided into five tracks, two pulses per track are determined, and their position and sign information is transmitted, the algebraic codebook is configured with a total of 10 pulses. If a subframe is divided into four tracks and modeling is performed by using two pulses for each track, then the algebraic codebook is configured with a total of eight pulses.

The process of searching an algebraic codebook in the ALCEP type voice codec is a process of searching a pulse stream of an excitation signal that minimizes the mean square error between the input voice and the synthesized voice as represented by Equation 1 shown below:

Eₖ=∥x−gHCₖ∥² [Equation1]

In Equation 1, ‘x’ is the primary target signal (x(n)) from which a prediction gain of an adaptive codebook has been removed, ‘g’ is a codebook gain, H=h^{t}h is a lower triangular Toeplitz convolution matrix, and Cₖ is an algebraic code vector with an index k.

Minimizing Equation 1 has the same meaning as maximizing Equation 2 shown below:

$${T}_{k} = \frac{{( {C}_{k} )}^{2}}{{E}_{k}} = \frac{{( {x}^{t} {HC}_{k} )}^{2}}{{C}_{k}^{t} {H}^{t} {HC}_{k}} = \frac{{( {d}^{t} {C}_{k} )}^{2}}{{C}_{k}^{t} Φ {C}_{k}} \qquad [ Equation 2 ]$$

In Equation 2, ‘d’ is a signal indicating a correlation between the primary target signal (x(n)) and the impulse response (h(n)), which is called an inversely filtered target signal, and Φ=H^{t}H is a correlation matrix of h(n).

Because the algebraic code vector (Cₖ) includes a small number of pulses, not zero, the numerator item in Equation 2 is represented by Equation 3 shown below, and the denominator item in Equation 2 is represented by Equation 4 shown below:

$${C}_{k} = {\sum }_{i = 0}^{{N}_{p} - 1} {s}_{i} d ( {m}_{i} ) \qquad [ Equation 3 ]$$

In Equation 3, mᵢ is the position of the ith pulse, sᵢ is the sign of a pulse, and Nₚ is the number of pulses.

$${E}_{k} = {\sum }_{i = 0}^{{N}_{p} - 1} φ ( {m}_{i} , {m}_{i} ) + 2 {\sum }_{i = 0}^{{N}_{P} - 1} {\sum }_{j = i + 1}^{{N}_{P} - 2} {s}_{i} {s}_{j} φ ( {m}_{i} , {m}_{j} ) \qquad [ Equation 4 ]$$

In order to reduce the amount of calculations required in the searching process, a d(m₁) signal and the correlation matrix Φ(mᵢ, mⱼ) may be calculated in advance before the searching process.

The algebraic codebook searching method, the focused search method, the depth first tree search method, and the similar methods are used as the entire search method to effectively perform searching because of the large number of pulse combinations.

The focused search method, aimed at simplifying the search process, is a method in which, before searching the last loop, only when a threshold value is exceeded by using a previously calculated threshold value, searching is continued on the loop.

The depth first tree search method, enhancing the focused search method, is a method in which a local maximum value of each track is selected as an initial pulse to select a locally optimum value to perform searching only on a tree with the highest possibility.

In the algebraic codebook algorithm, in order to effectively model an excitation signal of a subframe, the subframe is divided into predetermined tracks and a predetermined number of pulses are allocated to each track. Also, the size of each pulse is previously set as ±1 in order to reduce the amount of calculation in the searching process.

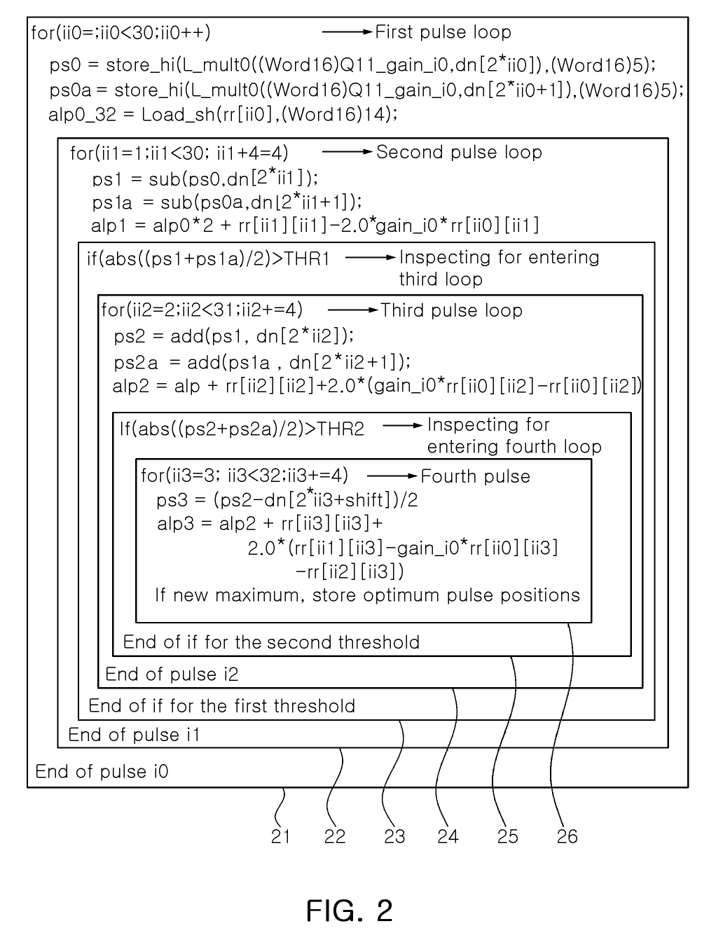

FIG. 2 illustrates C codes used for searching the algebraic codebook of a TETRA codec, one of the ACELP-type voice codecs.

In FIG. 2, C codes of 21, 22, 24, and 26 represent a nested loop, and the C codes of 23 and 25 are used to check a threshold value to determine whether to join the nested loop.

With reference to those C codes, it is noted that rr[ ] [ ], an autocorrelation matrix of h(n) of the impulse response is used repeatedly in searching the algebraic codebook.

When energy (E) of the denominator term in Equation 2

$${T}_{k} = \frac{{( {C}_{k} )}^{2}}{{E}_{k}} = \frac{{( {x}^{i} {HC}_{k} )}^{2}}{{C}_{k}^{t} {H}^{t} {HC}_{k}} = \frac{{( {d}^{t} {C}_{k} )}^{2}}{{C}_{k}^{t} Φ {C}_{k}}$$

is calculated, computation as shown in Equation 5 below is made, for which the correlation matrix Φ(mᵢ, mⱼ) is repeatedly used.

E=a²Φ(m₀,m₀)+Φ(m₁,m₁)−2aΦ(m₀,m₁)+Φ(m₂,m₂)+2aΦ(m₀,m₂)−2aΦ(m₁,m₂)+Φ(m₃,m₃)−2aΦ(m₀,m₃)+2Φ(m₁,m₃)−2Φ(m₂,m₃) [Equation 5]

In this case, the values Φ(mᵢ, mⱼ) are calculated before performing searching and stored in the memory.

The values Φ(mᵢ, mⱼ) are in the matrix form, so in case of implementation of the C code, preferably, the values Φ(mᵢ, mⱼ) are stored in the memory of the two-dimensional array structure, but as described above, in case of the actual real time implemented in the DSP, the values Φ(mᵢ, mⱼ) are stored in the one-dimensional memory.

As a result, many cycles are required to generate addresses to access the values Φ(mᵢ, mⱼ) stored in the one-dimensional memory. Namely, the calculation amount of addresses increases.

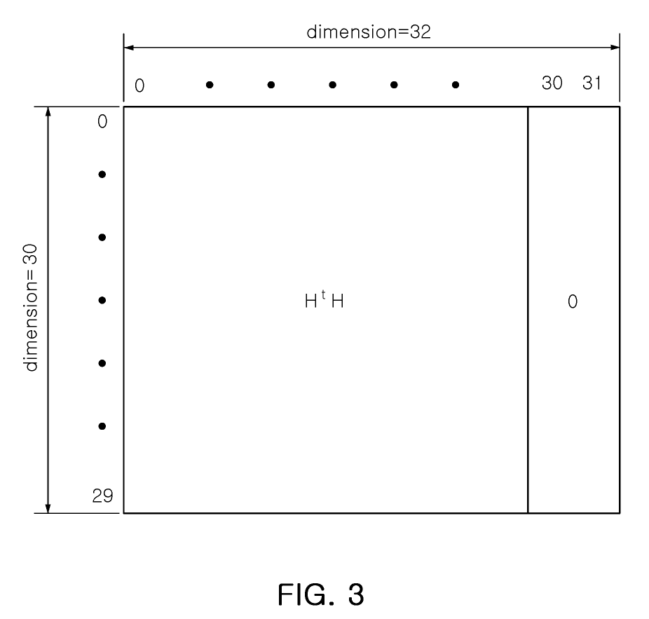

For example, in case of the TETRA codec, the correlation matrix is configured as shown in FIG. 3.

In case of the TETRA codec, although the length of subframe is 60, only correlation values with respect to even numbers are required, so the actual length of the impulse response (h(n)) is 30. Thus, a correlation matrix with respect to the impulse response of h(0) to h(29) may be obtained, but in terms of the track configuration of the algebraic codebook, the dimension of the correlation matrix is 32, making the [30]th and [31]st elements of the correlation matrix become 0.

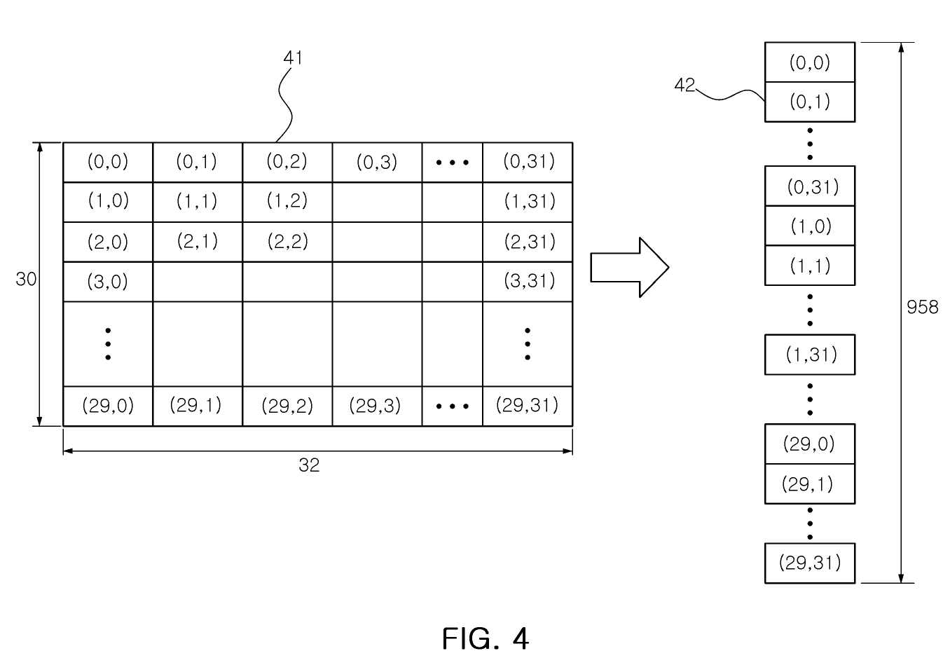

FIG. 4 illustrates the process of storing a correlation matrix array of FIG. 3 in a one-dimensional memory when a correlation matrix array 41 is implemented in real time by using a DSP.

The correlation matrix of FIG. 4 is a matrix in which lower triangle and higher triangle elements are the same, namely, rr[i][j]=rr[j][i], based on diagonal elements of rr[0][0] to rr[29][29]. An address number of the final element of this matrix in the one-dimensional memory, namely, rr[29][29], is ‘32×29+29=957’.

As afore-mentioned, in the nested loop type performing process that occupies the largest amount of calculation in the algebraic codebook searching process, variable values of the two-dimensional matrix structure are continuously used for searching the algebraic codebook.

Thus, in the case of real time implementation, the design of an address generator facilitating access when the variable values having the two-dimensional matrix structure are implemented as a one-dimensional memory could lead to a significant reduction in the amount of calculation required in searching the algebraic codebook.

However, in the related art, when accessing the variable values of the two-dimensional matrix structure on the C codes as shown in FIG. 2, the matrix structure 41 in the two-dimensional array is implemented into a one-dimensional memory 42 as shown in FIG. 4, complicating the address calculation process and requiring a larger amount of calculation.

The address calculation process may be implemented in an assembly language of TI DSP 54X series, commonly used among the general DSPs as follows:

| C code | Assembly code |
|---|---|
| rr[ii0][ii2] | STM #32, T |
| | MPY @ii0, A |
| | ADD @ii2, A |
| | ADD #rr, A |
| | STLM A, AR3 |

Here, 32 is the dimension of the matrix, and #rr is a start address, namely, an offset address, of the matrix.

In case of actual implementation in the assembly language to access the two-dimensional variable value rr[ii0] [ii2] in the C codes of FIG. 2, five commands are required, and as a result, a calculation amount of about five cycles is required.

Such calculations must be continuously repeated in the algebraic codebook searching process, thus it is the major factor in increasing the amount of calculations required in the algebraic codebook searching process.

Therefore, the present application proposes an address generator capable of configuring such five commands as a single command in order to drastically reduce the amount of calculation required for the address calculation process.

Namely, the present application proposes an address generator capable of generating an address for accessing the one-dimensional memory in a novel manner from variable values of a two-dimensional array storing correlation matrix values in searching an algebraic codebook.

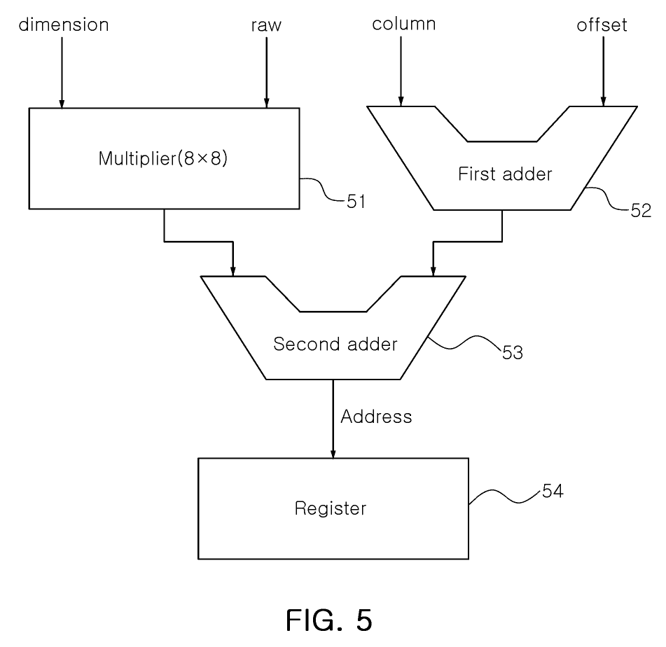

FIG. 5 is a schematic block diagram of an address generator according to an exemplary embodiment of the present invention.

With reference to FIG. 5, the address generator according to an exemplary embodiment of the present application includes a multiplier 51 that multiplies the size (i.e., dimension) and a width value (i.e., row) of a correlation matrix, a first adder 52 that adds a length value (i.e., column) and an offset address, a second adder 53 that adds the calculation results of the multiplier 51 and the first adder 53, and a register 54 that stores the calculation result of the second adder 53.

The address generator according to an exemplary embodiment of the present application replaces the above-mentioned five commands into a single command as follows, to thereby generate an address for accessing the one-dimensional memory from the address in a two-dimensional array.

STM & (raw, column), AR3

Here, raw is the width value of the address in the two-dimensional array, column is the length value of the address in the two-dimensional array, and AR3 is the register 54 that generates the operation result value of the address generator.

For reference, in view of the algebraic codebook searching process, the operation of the address generator of FIG. 5 is performed to generate an address for bringing about (fetching) two-dimensional correlation values from the one-dimensional memory, but in view of the DSP hardware, the operation of the address generator of FIG. 5 may be considered a command for generating a particular value and storing it in the register.

Thus, the address generator according to an exemplary embodiment of the present application may be actually regarded as hardware that performs a particular command discriminated from an address generation block of DSP hardware.

The address value generated through the address generator is an address to be first accessed in the correlation matrix memory, and actually, addressing is performed as address register values increase by a step value in the nested loop.

In the present invention, the amount of bit calculation of the multiplier 51 is set as 8×8 (bit×bit), but it can be actively changed according to the characteristics of the ACELP voice codec. For example, if the address generator according to the exemplary embodiment of the present application is applied to the TETRA codec, the multiplier 51 may be designed to have a 5×5 form, and it would be sufficient for the first and second adders 52 and 53 to have 16 bits.

The dimension of the matrix and the offset address are previously set outside the nested loop, and within the nested loop, only the width value (row) and the length value (column) are supplied as operands.

In this manner, the address generator according to the exemplary embodiment of the present application replaces the five commands as in the related art with a single command and generates an address for accessing the one-dimensional memory from the width value (row) and the length value (column), the addresses of the two-dimensional array.

Hereinafter, the effect of reducing the amount of address calculation required for accessing the matrix memory in searching the ACELP algebraic codebook searching in case of using the address generator according to an exemplary embodiment of the present application will now be described.

Such prediction is greatly affected by DSP hardware, so in the present invention, the effect of reducing the amount of address calculation will be described based on TI 320C54X.

First, in case of the TETRA codec, the number of searches in the nested loop of the C codes as shown in FIG. 2 can be calculated as follows:

1) In cases where search numbers do not exceed a first threshold value (THR1) at all: 30×8=240

2) In cases where search numbers all exceed the first threshold value (THR1) but do not exceed a second threshold value (THR2) at all: 30×8×8=1,920

3) In cases where search numbers all exceed the first and second threshold values (THR1 and THR2): 30×8×8×8=15, 360.

In this respect, however, if the search numbers exceed one of the two threshold values even once, a logic limiting the maximum search number operates, so the actual search number would be greatly reduced when compared with the search numbers as mentioned above.

The logic for limiting the maximum search number is set such that, a counter is set as 350 before entering the loop, if a search number has passed the first threshold value (THR1), 4 is reduced, and when a search number has passed the second threshold value (THR2), namely, when the innermost loop is performed, 3 is reduced.

Thus, when the maximum search number limiting logic is applied, the two innermost loop searches are actually performed about thirteen times. Thus, the maximum search numbers are reduced as follows:

1) In cases where search numbers do not exceed a first threshold value (THR1) at all: 30×8=240

2) In cases where search numbers all exceed the first threshold value (THR1) but do not exceed a second threshold value (THR2) at all: 153+87×8=849

3) In cases where search numbers all exceed the first and second threshold values (THR1 and THR2): 227+13×64=1,059.

With reference to the C codes with respect to the search numbers and the search loops, the required amount of calculation for the address calculation with respect to the matrix memory can be calculated, and accordingly, the extent to which the calculation may be reduced by using the address generator according to the exemplary embodiment of the present application can be predicted.

Based on the C codes for the searching loops of FIG. 2, address calculation with respect to the memory is required as follows: rr[i0][i0] in the first loop, rr[i1][i1], rr[i0][i1] in the second loop, rr[i2][i2], rr[i0][i2], rr[i1] [i2] in the third loop, and rr[i3] [i3], rr[i1][i3], rr[i0][i3], rr[i2][i3] in the fourth loop.

If it is assumed that the dimension of the matrix in the afore-mentioned assembly code is set as 32, because the number of cycles required for each address calculation is 4, the required amount of calculations in consideration of the search numbers in the entire loops as calculated above is calculated as follows:

1) {30+30×2+(8×3+8×8×4)×13}×4=149,200

2) 14,920×4 subframes×33 frame/sec=1.97 MIPS

However, the use of the address generator according to the exemplary embodiment of the present application allows a one-fourth reduction (i.e., twenty-five percent reduction), so the amount of calculation for an address search can be finally reduced to about 0.5 MIPS.

In addition, in case of a G.729 codec, the search numbers in the loops of the C codes as shown in FIG. 2 may be calculated as follows:

1) In cases where search numbers do not exceed a threshold value at all: 8×8×8=512

2) In cases where search numbers all exceed the threshold value: 8×8×8×16=8,192

In this respect, however, when the search numbers exceed the threshold value, the logic for limiting the maximum search number operates, so the actual search numbers are significantly reduced compared with the search numbers as above.

The logic for limiting the maximum search number is determined by counting the numbers required in performing the final loop in excess of the threshold value. Thus, when the maximum search number limiting logic is actually applied, the innermost loop is performed 105 times at a first subframe and 180 times at a second subframe.

1) In cases where search numbers do not exceed a threshold value at all: 8×8×8=512

2) In cases where search numbers all exceed the threshold value:

3) Subframe0: 3: (512−105)+105×16=2,087,

4) Subframe1: (512−180)+180×16=3,212

5) Accessing the memory in the two-dimensional matrix form within the loop is very similar to that of the TETRA codec, so the number of cycles required for each address calculation can be seen as follows:

1) {(8+8×2+8×8×3)×(512−105)/512+105×16×4}×4+{(8+8×2+8×8×3)×(512−180)/512+180×16×4}×4=27,568+46,640=74,208,

2) 74,208×100 frame/sec=7.4 MIPS

Here, it is noted that the use of the matrix address generator according to the exemplary embodiment of the present application can reduce the amount of calculations to one-fourth (i.e., twenty-five percent of the original amount), resulting in a reduction of calculation of about 1.85 MIPS.

As set forth above, the address generator for searching an algebraic codebook according to exemplary embodiments of the invention can simply generate an address value of the memory that stores correlation matrix values, to thus reduce the amount of address calculation required to access correlation matrix values forming a great deal of weight in the algebraic codebook searching process. Thus, the efficiency of searching the algebraic codebook can be increased and the computation speed can be improved.

While the present application has been shown and described in connection with the exemplary embodiments, it will be apparent to those skilled in the art that modifications and variations can be made without departing from the spirit and scope of the invention as defined by the appended claims.

What is claimed is:

1. An address generator comprising:
a multiplier multiplying a dimension and a width value of a correlation matrix;
a first adder adding a length value and an offset address of the correlation matrix; and
a second adder adding the results of the multiplier and the first adder to generate an address for algebraic codebook searching.

2. The address generator of claim 1, further comprising:
a register storing the computation results of the second adder.

3. The address generator of claim 1, wherein the address generated by the second adder is an address to be first accessed in a memory of the correlation matrix.

4. An encoding device of an ACELP-type voice codec comprising:
an address generator generating an address to access a memory, wherein the memory stores correlation matrix values in one-dimensional array;
an algebraic codebook searching unit accessing the memory using the address to obtain the correlation matrix values required for searching an algebraic codebook.

5. The encoding device of an ACELP-type voice codec of claim 4, wherein the correlation matrix values are two-dimensional array values.

6. The encoding device of an ACELP-type voice codec of claim 5, wherein the address generator comprising:
a multiplier multiplying a dimension and a width value of a correlation matrix;
a first adder adding a length value and an offset address of the correlation matrix; and
a second adder adding the results of the multiplier and the first adder to generate an address for algebraic codebook searching.

7. The encoding device of an ACELP-type voice codec of claim 6, wherein the address generator further comprising:
a register storing the computation results of the second adder.

8. The encoding device of an ACELP-type voice codec of claim 6, wherein the address generated by the second adder is an address to be first accessed in a memory of the correlation matrix.
